(19) United States
(12) Patent Application Publication
(10) Pub. No.: US 2023/0220216 A1
(43) Pub. Date: Jul. 13, 2023

(54) COMPOSITIONS AND PROCESSES OF FORMING 3D PRINTABLE MATERIALS CAPABLE OF LOW DIELECTRIC LOSS

(71) Applicant: Arkema France, Colombes (FR)

(72) Inventors: Neal Pfeiffenberger, Exton, PA (US); Brendan McGrail, Exton, PA (US); Jon Scholte, Exton, PA (US)

(21) Appl. No.: 18/010,477

(22) PCT Filed: Jun. 17, 2021
(86) PCT No.: PCT/EP2021/066396

§ 371 Date: Dec. 15, 2022

(30) Foreign Application Priority Data
Jun. 18, 2020 (FR) FR2006364

(51) Int. Cl. C09D 4/06; C09D 135/02; C09D 171/12; C09D 5/18; C09D 7/61; H01Q 1/42; B33Y 70/00; B33Y 80/00

(52) U.S. Cl. CPC C09D 4/06; C09D 135/02; C09D 171/12; C09D 5/18; C09D 7/61; H01Q 1/42; B33Y 70/00; B33Y 80/00; B29C 64/124

(57) ABSTRACT

Disclosed are photo-curable compositions and processes to produce a 3D high-frequency dielectric material for use as an insulator in a circuit such as, for example, a high-performance RF component such as, for example, an antenna for electromagnetic transmission, a filter, a transmission line, or a high frequency interconnect. The high frequency circuit structures have a very low dielectric loss at operating frequencies (1-60 GHz).

### BACKGROUND

The present disclosure provides photo-curable compositions and uses thereof as 3D printing inks to print 3D high frequency dielectric material for use as circuit structures such as, for example, insulators for antennas.

With the development of electronic information technology, the miniaturization and densification of electronic equipment installation, the high capacity and high frequency of information, in recent years, higher demands are put forward for the overall performances of circuit substrates, such as thermal resistance, water absorption, chemical resistance, mechanical property, and dielectric properties.

As to the dielectric properties, the transmission rate of signals and the dielectric constant Dk of insulating materials in high frequency circuits have the following relation, i.e., the lower the dielectric constant Dk of insulating materials is, the faster the transmission rate of signals is. Thus, substrates having low dielectric constant need to be developed to achieve high speed of the transmission rate of signals. Along with high frequency of the signal, the signal loss from the substrates (D_{f}) cannot be ignored. Therefore it has become a common research direction for copper-clad laminate (CCL) manufacturers to develop high frequency circuit substrates having low dielectric loss DF, and low but tuned dielectric constant Dk.

3D printing has enabled new designs for substrates and more specifically for RF structures such as, for example, antennas. Conventionally, an antenna is made on a flat 2D substrate where the substrate material is as low of a loss at the frequency of use. In most cases, this material is based on PTFE, LCP, or other non-polar resins (including epoxy, SMA, Polybutadiene, and PPE/PPO) and filled with an inorganic material to help lower the coefficient of thermal expansion, decrease loss, and increase breakdown strength. In such cases, the antenna's conductor is not always capable of being in an optimized orientation since it needs to be deposited onto a 2D substrate. With the advent of 3D printing, antenna designs can now be optimized for the signal propagation/reception but the dielectric material surrounding the antenna has less than optimal electronic properties. Extrusion based fused deposition modeling (FDM) 3D printing has low loss thermoplastic resins like PC, PEI, PPS, PP, ABS, etc., but FDM printing cannot offer the high resolution and low surface roughness required to surround high frequency signals like a UV or other energy curable system. This is because the signal sits on the outermost area of the conductor (typically conductive ink or rod, foil, or wire) and the signal propagation is related to the surface roughness and current carrying capability of this conductor as well as to the surface roughness of the dielectric material surrounding it.

Recent research has shown that a 3D printed RF structure can give a 43 dB increase in the maximum rejection of the S-parameters over a wider frequency range compared to a planar counterpart (Hester et. al). Current 3D printed UV-based materials do not have a low enough dielectric loss compared to conventional FDM thermoplastics, but have the resolution/surface roughness required for high frequency applications. Traditional UV curable 3D printing resins are acrylic based which are typically very high in dielectric loss over a wide range of usable frequencies as the backbones and end groups of many of these materials are highly polar.

Thus, there is a need in the art for low-loss dielectric materials that are UV or energy curable and are highly non-polar. Long, non-polar backbones with low to no water absorption are desired with as high of a Mw of the non-polar backbone as possible (while still being processable at the printing temperature) to offset the polarity needed by the polar acrylate and methacrylate based end groups (or other functionalities).

### BRIEF SUMMARY

In one aspect, disclosed herein is a photo-curable composition suitable for printing a three-dimensional (3D) high-frequency circuit structure, the photo-curable composition comprises, consists essentially of, or consists of:

a. at least one (meth)acrylated polydiene derivative;

b. at least one ethylenically unsaturated isocyanurate or cyanurate;

c. optionally, at least one aromatic vinyl monomer;

d. optionally, at least one functionalized poly(phenylene ether) having the following structure:

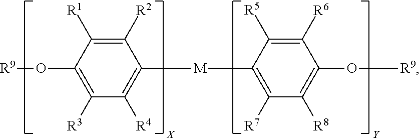

wherein 1≤x≤100; 1≤y≤100; 2≤x+y≤100; the examples are 15<x+y<30; 25<x+y<40; 30<x+y<55; 60<x+y<85; 80<x+y<98;

M is selected from the group consisting of:

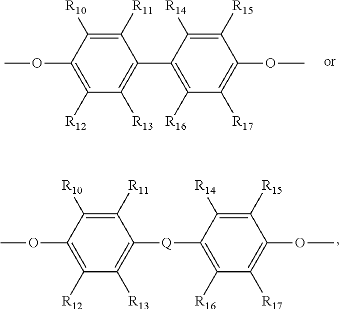

wherein Q is any one selected from the group consisting of —O—, —CO—, SO, —SO₂—, and —CH₂—, —C(CH₃)₂—;

R₂, R₄, R₆, R₈, R₁₁, R₁₃, R₁₅ and R₁₇ are all any one independently selected from the group consisting of a hydrogen atom, substituted or unsubstituted C₁-C₈ linear chain alkyl group, substituted or unsubstituted C₁-C₈ branched chain alkyl group and substituted or unsubstituted phenyl;

R₁, R₃, R₅, R₇, R₁₉, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

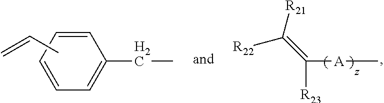

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms;

e. at least one photo-initiator;

f. at least one diluent selected from the group consisting of an aryl difunctional (meth)acrylate monomer, an alkyl (meth)acrylate monomer; and a polyfunctional (meth)acrylate monomer; and

g. optionally, at least one photoblocker.

In another aspect, disclosed here is a process of forming a three-dimensional (3D) high-frequency dielectric material for use as an insulating component of a circuit, said process comprising the steps of:

I) irradiating a region of a photo-curable composition at a site of irradiation to form a cured region; and

II) causing relative movement between the site of irradiation and the cured region to grow the cured region in the direction of the movement layer, wherein the photo-curable composition comprises, consists essentially of, or consists of:

a. at least one (meth)acrylated polydiene derivative;

b. at least one ethylenically unsaturated isocyanurate or cyanurate;

c. optionally, at least one aromatic vinyl monomer;

d. optionally, at least one functionalized poly(phenylene ether) having the following structure:

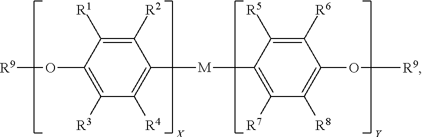

wherein 1≤x≤100; 1≤y≤100; 2≤x+y≤100; the examples are 15<x+y<30; 25<x+y<40; 30<x+y<55; 60<x+y<85; 80<x+y<98;

M is selected from the group consisting of:

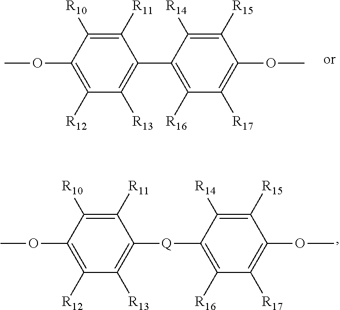

wherein Q is any one selected from the group consisting of —O—, —CO—, SO, —SO₂—, and —CH₂—, —C(CH₃)₂—;

R₂, R₄, R₆, R₈, R₁₁, R₁₃, R₁₅ and R₁₇ are all any one independently selected from the group consisting of a hydrogen atom, substituted or unsubstituted C₁-C₈ linear chain alkyl group, substituted or unsubstituted C₁-C₈ branched chain alkyl group and substituted or unsubstituted phenyl;

R₁, R₃, R₅, R₇, R₁₀, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

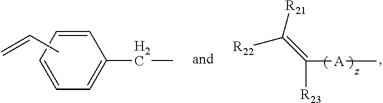

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms;

e. at least one photo-initiator;

f. at least one diluent selected from the group consisting of an aryl difunctional (meth)acrylate monomer; an alkyl (meth)acrylate monomer; and a polyfunctional (meth)acrylate monomer; and

g. optionally at least one photoblocker.

In another aspect, the invention contemplates an article which is an electrical circuit comprising a conductor and an insulating component made according to the process of forming a three-dimensional (3D) high-frequency dielectric material as described herein.

### DETAILED DESCRIPTION OF THE INVENTION

Embodiments described herein can be understood more readily by reference to the following detailed description, examples, and drawings. Elements, apparatus and processes described herein, however, are not limited to the specific embodiments presented in the detailed description, examples, and drawings. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “from 5 to 10” or “5-10” should generally be considered to include the end points 5 and 10.

When the phrase “up to” is used in connection with an amount or quantity, it is to be understood that the amount is at least a detectable amount or quantity. For example, a material present in an amount “up to” a specified amount can be present from a detectable amount and up to and including the specified amount.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The terms “three-dimensional printing system,” “three-dimensional printer,” “printing,” and the like generally describe various solid freeform fabrication techniques for making three-dimensional articles or objects by stereolithography, selective deposition, jetting, fused deposition modeling, multi-jet modeling, digital light processing, gel deposition, continuous light interface printing, and other additive manufacturing techniques now known in the art or that may be known in the future that use a build material or ink to fabricate three-dimensional objects.

As used herein, “(meth)acrylate” is inclusive of both acrylate and methacrylate functionality.

As intended herein, a “resin” means a composition capable of being polymerized or cured, further polymerized or cured, or crosslinked. Resins may include monomers, oligomers, prepolymers, or mixtures thereof.

As used herein, a dash (“—”) that is not between two letters or symbols is used to indicate a point of attachment for a substituent. For example, (C₁-C₄ alkyl)S— is attached through the sulfur atom.

As used herein, “alkyl” includes both branched and straight chain saturated aliphatic hydrocarbon groups, having the specified number of carbon atoms. Examples of alkyl include, but are not limited to, methyl, ethyl, n-propyl, isopropyl, n-butyl, 3-methylbutyl, t-butyl, n-pentyl, and sec-pentyl.

As used herein, the term “monomer” refers to organic compounds having a relatively low molecular weight (e.g., generally less than 200 Da), and which may undergo chemical self-reaction (e.g., polymerization) or chemical reaction with other monomers (e.g., copolymerization) to form longer chain oligomers, polymers and copolymers.

As used herein, the term “oligomer” is understood to refer to an organic substance that contains a plurality of repeating units (e.g., oxyalkylene repeating units) and a polydispersity (Mw/Mn) greater than 1. A monomer may or may not contain a plurality of repeating units, but is a discrete, single molecule. For example, 2(2-ethoxy ethoxy) ethyl acrylate contains two oxyethylene repeating units, but is considered a monomer rather than an oligomer since it is a compound having a defined structure rather than a mixture of structurally related compounds having a distribution of molecular weights (and thus a polydispersity >1).

The term “molecular weight” as used throughout this specification unless otherwise indicated means a discrete molecular weight for a monomer and, for an oligomer or polymer, a number average molecular weight unless expressly noted otherwise, determined by gel permeation chromatography, using polystyrene standards and THF as the mobile phase, for comparison and is measured within five minutes after completion of the synthesis of the oligomer.

### Compositions

The present disclosure provides a resin composition having a low dielectric constant Dk and a low dielectric loss factor Df, and excellent thermal resistance and interlayer adhesive force, so as to meet the requirements of high frequency circuit substrates on dielectric properties, thermal resistance, and interstratified adhesive force, and also be able to be used for preparing high frequency circuit substrates.

In one aspect, provided herein are photo-curable compositions suitable for 3D printing materials for the realization of high performance RF components such as, for example, antennas, filters, transmission lines, and interconnects. The compositions disclosed herein produce high performance insulating RF components that exhibit less dielectric loss, have less surface roughness, and better print resolution that prior art compositions. The compositions disclosed herein comprise:

a. at least one (meth)acrylated polydiene derivative;

b. at least one ethylenically unsaturated isocyanurate or cyanurate;

c. optionally, at least one aromatic vinyl monomer;

d. optionally, at least one functionalized poly(phenylene ether) having the following structure:

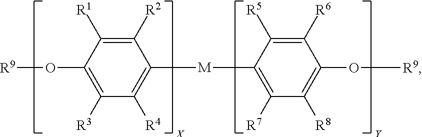

wherein 1≤x≤100; 1≤y≤100; 2≤x+y≤100; the examples are 15<x+y<30; 25<x+y<40; 30<x+y<55; 60<x+y<85; 80<x+y<98;

M is selected from the group consisting of:

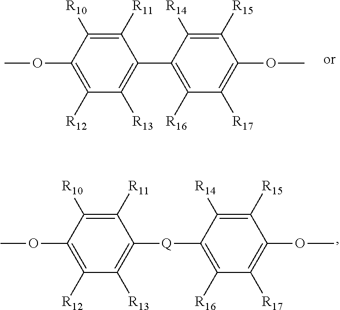

wherein Q is any one selected from the group consisting of —O—, —CO—, SO, —SO₂—, and —CH₂—, —C(CH₃)₂—;

R₂, R₄, R₈, R₈, R₁₁, R₁₃, R₁₅ and R₁₇ are all any one independently selected from the group consisting of a hydrogen atom, substituted or unsubstituted C₁-C₈ linear chain alkyl group, substituted or unsubstituted C₁-C₈ branched chain alkyl group and substituted or unsubstituted phenyl;

R₁, R₃, R₅, R₇, R₁₀, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

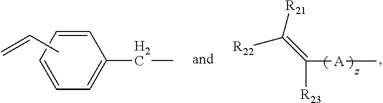

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms;

e. at least one photo-initiator;

f. at least one diluent selected from the group consisting of an aryl difunctional (meth)acrylate monomer, an alkyl (meth)acrylate monomer; and a polyfunctional (meth)acrylate monomer; and

g. optionally, at least one photoblocker.

Each component will be described in more detail herein.

### At Least One (Meth)Acrylated Polydiene Derivative

The compositions disclosed herein comprise at least one (meth)acrylated polydiene derivative. This constituent serves as an elastomer and aids in blocking moisture.

Suitable (meth)acrylated polydiene derivatives include oligomers which may be described as substances comprising an oligomeric polydiene backbone which is functionalized with one or more (meth)acrylate groups (which may be at a terminus of the oligomer and/or pendant to the polydiene backbone). The polydiene backbone may be at least partially hydrogenated. The polydiene backbone may be alkoxylated. The polydiene backbone may be a homopolymer, random copolymer or block copolymer comprised of repeating units derived from the polymerization of at least one diene monomer. Examples of suitable diene monomers may be any monomeric conjugated diene such as 1,3-butadiene, isoprene, 1,3-pentadiene, 1,3-hexadiene, 2,3-dimethyl-1,3-butadiene, 2-ethyl-1,3-butadiene, 2-methyl-1,3-penta-diene, 3-methyl-1,3-pentadiene, 4-methyl-1,3-pentadiene, 2,4-hexadiene, and mixtures thereof, preferably 1,3-butadiene. The polydiene backbone may further comprise repeating units derived from the polymerization of at least one non-diene monomer such as, for example, a monoethylenically unsaturated monomer (for example styrene, acrylonitrile), a polycarboxylic acid, a cyclic anhydride, a polyol, a cyclic ether, a polyisocyanate, a polyepoxide, and mixtures thereof. Preferably, the (meth)acrylated polydiene derivative comprises a (meth)acrylated homopolymer or copolymer of 1,3-butadiene which may be optionally hydrogenated.

The at least one (meth)acrylated polydiene derivative may be selected from at least one of a (meth)acrylated hydroxy-polydiene, a polydiene-based epoxy (meth)acrylate, a polydiene-based polyester (meth)acrylate, a polydiene-based urethane (meth)acrylate and combinations thereof.

A (meth)acrylated hydroxy-polydiene may be the reaction product of a hydroxy-polydiene with (meth)acrylic acid or a derivative thereof. As used herein the term “hydroxy-polydiene” means a polydiene bearing one or more hydroxy groups. The hydroxy-polydiene may be an hydroxylated polybutadiene, in particular a hydroxylated polybutadiene bearing two hydroxy groups. Derivatives of (meth)acrylic acid include any compound with a (meth)acryloyl group that is able to form an ester bond with a hydroxy-functionalized compound, such as (meth)acryloyl halides, (meth)acrylic anhydride and C1-C10 alkyl esters of (meth)acrylic acid.

A polydiene-based epoxy (meth)acrylate may be an epoxy (meth)acrylate comprising one or more moieties derived from an epoxy-polydiene. As used herein, the term “epoxy (meth)acrylate” means the reaction product of at least one epoxy-functionalized compound with (meth)acrylic acid. As used herein the term “epoxy-polydiene” means a polydiene bearing one or more epoxy groups. The epoxy-polydiene may be obtained by epoxidation of at least part of the double bonds contained in a polydiene. In particular, the epoxy-polydiene may be an epoxidized polybutadiene.

A polydiene-based polyester (meth)acrylate may be a polyester (meth)acrylate comprising one or more moieties derived from a hydroxy-polydiene or a carboxy-polydiene. As used herein the term “carboxy-polydiene” means a polydiene bearing one or more carboxylic acid groups. As used herein, the term “polyester (meth)acrylate” means the reaction product of at least one hydroxy group-terminated polyester with (meth)acrylic acid or a derivative thereof or the reaction product of at least one carboxylic acid group-terminated polyester with glycidyl (meth)acrylate. The hydroxy group-terminated polyester or the carboxylic acid group-terminated polyester may be obtained by polycondensation reaction of at least one polyol (in particular a diol) and at least one polycarboxylic acid or a derivative thereof (in particular, a dicarboxylic acid or a cyclic anhydride). In particular, the polyol may comprise a polybutadiene polyol, more particularly a polybutadiene diol. In particular, the polycarboxylic acid may comprise a polybutadiene polycarboxylic acid, more particularly a polybutadiene dicarboxylic acid.

A polydiene-based urethane (meth)acrylate may be a urethane (meth)acrylate comprising one or more moieties derived from a hydroxy-polydiene. As used herein, the term “urethane (meth)acrylate” means the reaction product of at least one polyol, at least one polyisocyanate and at least one hydroxy-functionalized (meth)acrylate.

Examples of (meth)acrylated polydiene derivative oligomers include, for example, a hydrophobic aliphatic urethane diacrylate (CN310 available from Sartomer Chemical Co., Exton, Pa.); a hydrophobic diacrylate ester (e.g., CN307, CN 308); a polydiene methacrylate (CN303 available from Sartomer Chemical Co., Exton, Pa.); and a blend of a polydiene methacrylate and an alkyl diacrylate (CN301 available from Sartomer Americas of Exton, Pa.).

The structures defined above feature low water absorption, a high molecular weight with a highly symmetric backbone, low shrinkage, and good flexibility. They offer flexibility to an otherwise rigid and/or brittle matrix but do have a higher viscosity which must be taken into consideration for processing challenges.

The at least one (meth)acrylated polydiene derivative can be present in the compositions at from about 2 wt. % to about 30 wt. %, preferably from about 10 wt. % to about 25 wt. %, and more preferably from about 11 wt. % to about 20 wt. %, and most preferably from about 12 wt. % to about 18 wt. %, based on the total weight of the composition.

At Least One Ethylenically Unsaturated Isocyanurate

Compositions disclosed herein comprise at least one ethylenically unsaturated isocyanurate. The at least one ethylenically unsaturated isocyanurate primarily functions to lower the dielectric loss at high frequency while maintaining good crosslinking properties.

In some embodiments, the at least one ethylenically unsaturated isocyanurate or cyanurate is at least one compound of Formula I:

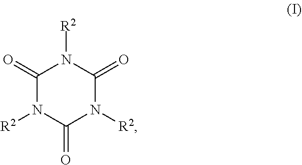

wherein R² is the same or different and is selected from the group consisting of hydrogen, lower alkyl, aryl, aralkyl, polynuclear aryl, heteroaryl, monofunctional lower-alkenyl and substituted derivatives thereof. Alkyl and substituted alkyl are intended to include from one to about 20 carbon atoms, straight or branch chained, and include, for example, (meth)acrylate, methyl, ethyl, chloroethyl, cyanopropyl, propyl, isopropyl, butyl, dibromobutyl, isobutyl, pentyl, hexyl, dodecyl and the like. By aryl, aralkyl, polynuclear aryl, heteroaryl and substituted derivatives thereof is intended to include phenyl, chlorophenyl, dibromophenyl, naphthyl, benzyl, pyridyl, cyanophenyl, tolyl, xylyl, phenanthryl and the like.

In a preferred embodiment, the at least one ethylenically unsaturated isocyanurate is triallyl isocyanurate (TAIC) (Product Name, SR533, manufactured by Sartomer Americas, Exton, Pa.):

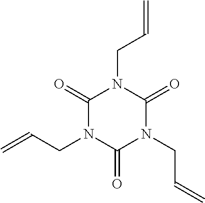 [SMILES: C=CCn1c(=O)n(CC=C)c(=O)n(CC=C)c1=O]

In another embodiment, the at least one ethylenically unsaturated isocyanurate is tris(2-hydroxy ethyl) Isocyanurate triacrylate (THEICTA) (product name SR368, Sartomer Americas, Exton, Pa.):

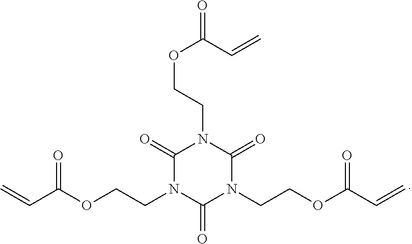 [SMILES: C=CC(=O)OCCn1c(=O)n(CCOC(=O)C=C)c(=O)n(CCOC(=O)C=C)c1=O]

Another example is the at least one ethylenically unsaturated isocyanurate is tris(2-hydroxy ethyl) Isocyanurate trimethacrylate (THEICTMA) (product name SR290, Sartomer Americas, Exton, Pa.)

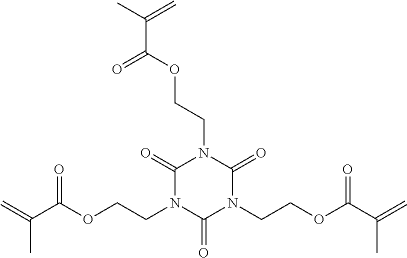 [SMILES: C=C(C)C(=O)OCCn1c(=O)n(CCOC(=O)C(=C)C)c(=O)n(CCOC(=O)C(=C)C)c1=O]

An example of an ethylenically unsaturated cyanurate is triallyl cyanurate (TAC) (product name SR 507A, Sartomer Americas, Exton, Pa.):

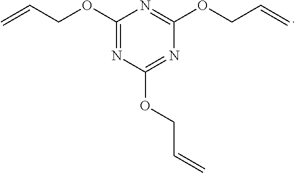 [SMILES: C=CCOc1nc(OCC=C)nc(OCC=C)n1]

The structures defined above feature very low dielectric loss due to high symmetry, a moderate viscosity, low moisture uptake, but can be brittle in the matrix at high loading levels.

The at least one ethylenically unsaturated isocyanurate or cyanurate can be present in the compositions at from about 1 wt. % to about 70 wt. %, preferably from about 10 wt. % to about 55 wt. %, and more preferably from about 35 wt. % to about 50 wt. %, based on the total weight of the composition.

It is preferred that the at least one ethylenically unsaturated isocyanurate or cyanurate is present in the composition at a concentration as high as possible without making the final product too brittle.

Optional Aromatic Vinyl Monomer

Compositions disclosed herein optionally comprise at least one aromatic vinyl monomer. The at least one aromatic vinyl monomer primarily functions to increase Tg and crosslinking density while maintaining low dielectric properties.

Examples of the aromatic vinyl monomer include styrene, 2-methylstyrene, 3-methylstyrene, 4-methylstyrene, a-methylstyrene, 2,4-dimethylstyrene, 2,4-diisopropylstyrene, 4-tert-butylstyrene, divinylbenzene, dibromostyrene, p-tertiary butylstyrene, tert-butoxystyrene, vinylbenzyldimethylamine, (4-vinylbenzyl)dimethylaminoethyl ether, N,N-dimethyl aminoethylstyrene, vinyl pyridine, and the like. In some embodiments, the at least one aromatic vinyl monomer is selected from the group consisting of p-methylstyrene, divinylbenzene, dibromostyrene, and 4-tert-butylstyrene.

The at least one aromatic vinyl monomer, when used, can be present in the compositions at from about 1 wt. % to about 25 wt. %, preferably from about 3 wt. % to about 20 wt. %, and more preferably from about 5 wt. % to about 10 wt. %, based on the total weight of the composition.

Optional Functionalized Polyphenylene Ether

Compositions disclosed herein optionally comprise at least one functionalized polyphenylene ether. The at least one functionalized polyphenylene ether may be used to provide a hydrophobic, ultra-low dielectric loss component as well as improved mechanical properties to the composition.

Preferably, the functionalized polyphenylether resin has the following structure:

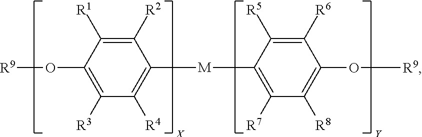

wherein 1≤x≤100; 1≤y≤100; 2≤x+y≤100; the examples are 15<x+y<30; 25<x+y<40; 30<x+y<55; 60<x+y<85; 80<x+y<98 :

M is selected from the group consisting of:

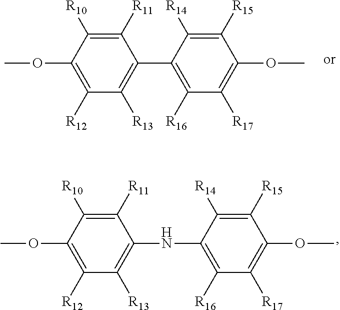

wherein N is any one selected from the group consisting of —O—, —CO—, SO, —SC—, —SO₂— and —C(CH₃)₂—;

R₂, R₄, R₆, R₈, R₁₁, R₁₃, R₁₅ and R₁₇ are all any one independently selected from the group consisting of substituted or unsubstituted C₁-C₈ linear chain alkyl group, substituted or unsubstituted C₁-C₈ branched chain alkyl group and substituted or unsubstituted phenyl; R₁, R₃, R₅, R₇, R₁₀, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

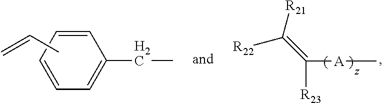

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms.

Preferably, the functionalized polyphenylether resin has a number-average molecular weight of 500-10,000 g/mol, preferably 800-8,000 g/mol, and more preferably 1,000-7,000 g/mol, determined in a manner as provided by the supplier. This material is a solid at room temperature and tends to increase the viscosity of the composition, which limits the maximum usable amount in the matrix. It does, however, feature low dielectric loss due to a symmetric backbone, low moisture uptake, and a high glass transition temperature (Tg), while adding a more rigid component to the matrix.

One example of a methacrylate-functionalized polyphenylether resin is SA9000 (SABIC, Saudi Basic Industries Corporation) which is bifunctional and has the structure:

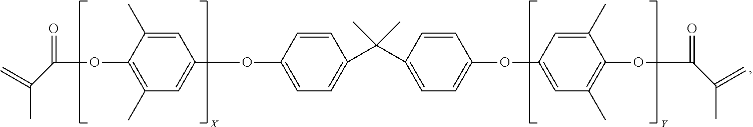

wherein x and y are defined as above.

The at least one functionalized polyphenylether can be present in the compositions at from about 0 wt. % to about 30 wt. % or from about 1 wt. % to about 30 wt. %, preferably from about 3 wt. % to about 25 wt. %, and more preferably from about 5 wt. % to about 20 wt. %, based on the total weight of the composition.

Preferably, the compositions disclosed herein has as high as possible an amount of the at least one functionalized polyphenylether without losing control of the composition's viscosity or dissolving fully into the solution.

Photo-Initiator

Compositions disclosed herein comprise a photo-initiator, which functions to initiate curing of the composition upon exposure to actinic radiation such as, for example, UV or visible radiation.

A single species of photo-initiator may be used or combinations of different species of photo-initiators. Any photo-initiator that absorbs radiation, e.g., UV or visible radiation, to induce free radical polymerization reactions between the selected oligomers and/or selected monomers may be used. Suitable, illustrative photoinitiators such as benzophenones, benzoin ethers, benzil ketals, a-hydroxyalkylphenones, α-alkoxyalkylphenones, aminoalkylphenones, and acylphosphine photo-initiators may be used. The photo-initiator 2,4,6 trimethylbenzoyldiphenylphosphine oxide (TPO) may be used.

The photo-initiator may be included in the composition in various suitable amounts. In embodiments, a composition includes from about 0.2 wt. % to about 15 wt. % of the photo-initiator, based on the total weight of the composition. This includes embodiments in which the composition includes from about 0.2 wt. % to about 10 wt. % or from about 1.0 wt. % to about 5 wt. % of the photo-initiator based on the total weight of the composition. In embodiments in which more than one species of photo-initiator is present in the composition, these amounts may refer to the total amount of photo-initiator in the composition.

At least one Diluent

Compositions disclosed herein comprise a diluent selected from the group consisting of an aryl difunctional (meth)acrylate monomer, an alkyl (meth)acrylate monomer; and a polyfunctional (meth)acrylate monomer. Preferably, the sole diluent is either an alkyl difunctional (meth)acrylate monomer or stearyl methacrylate, preferably an alkyl difunctional (meth)acrylate monomer. The first diluent is low loss, high hardness, low viscosity compound. Preferably, the first diluent contributes to the hardness of the cured product made by curing the photo-curable composition of the present invention. Preferably, the first diluent serves to maintain crosslinking to enable printabilty while simultaneously keeping viscosity in a printable range.

In an embodiment of the invention, the diluent comprises an alkyl (meth)acrylate monomer, which is at least one of an alkyl monofunctional acrylate and an alkyl monofunctional methacrylate. In another embodiment of the invention, the diluent comprises polyfunctional (meth)acrylate monomer, which is at least one of an alkyl difunctional acrylate and an alkyl difunctional methacrylate. In embodiments, the diluents comprise one or more of each of these or a combination thereof.

The first monomer may be an alkyl difunctional (meth)acrylate monomer which is an alkyl difunctional (meth)acrylate whose alkyl group has 1 to 20 carbon atoms. Specific examples thereof include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, and other suitable di-(meth)acrylates. These can be used singly as one species or in a combination of two or more species. In an embodiment of the invention, the first diluent is a cycloalkyl difunctional methacrylate. Most preferably, the first diluent is tricyclodecanedimethanol dimethacrylate, commercially available from Sartomer Americas as SR834. The first diluent preferably has a high Tg (e.g., at least about 160° C., preferably at least about 180° C., and most preferably at least about 200° C.), and preferably has a Tg of at most 240° C., more preferably at most 220° C. The first diluent preferably has a viscosity at 25° C., using the 21 spindle at 50RPM, of preferably at most 2,500 mPas, more preferably at most 1,000 mPa·s, still more preferably at most 500 mPa·s, and most preferably at most 200 (mPa·s 25° C.).

The first diluent may be included in the present curable compositions in various suitable amounts. In embodiments, the first diluent may present in the curable composition in an amount ranging from about 1 weight % to about 40 weight %, based on the total weight of the curable composition. Preferably, the first diluent is present in an amount ranging from about 1 weight % to about 30 weight ° A), from about 5 weight % to about 20 weight ° A), from about 8 weight ° A) to about 18 weight %, based on the total weight of the curable composition.

In embodiments of the invention, the photo-curable composition further comprises a second diluent selected from the group consisting of an alkyl (meth)acrylate monomer and a polyfunctional (meth)acrylate monomer, preferably a difunctional (meth)acrylate monomer. The second diluent serves to lower viscosity, maintain low dielectric loss, and prevent brittleness. If the viscosity, dielectric loss, and brittleness are adequate for the particular application in the absence of any second diluent, then no second diluent is required.

The alkyl (meth)acrylate compound may be an alkyl (meth)acrylate whose alkyl group has 1 to 20 carbon atoms. Specific examples thereof include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, n-heptyl (meth)acrylate, n-octyl (meth)acrylate, isooctyl (meth)acrylate, 2-ethylhexyl (meth)acrylate, n-nonyl (meth)acrylate, isononyl (meth)acrylate, decyl (meth)acrylate, lauryl (meth)acrylate, stearyl (meth)acrylate, etc. These can be used singly as one species or in a combination of two or more species.

Preferred (meth)acrylate monomers include Lauryl Acrylate; SR 587 (Acrylic Ester, Behenyl Acrylate); CD 421A/ SR421 (3,3,5-trimethylcyclohexyl methacrylate); SR 484 (Octyl Decyl Acrylate); SR 489D (Tridecyl Acrylate); SR 242 (Isodecyl Methacrylate); SR 313 (lauryl methacrylate); SR 257 (stearyl acrylate); and SR 324 (stearyl methacrylate), all available commercially from Sartomer Americas, Exton, PA. In preferred embodiments to achieve an especially low dielectric loss, the alkyl (meth)acrylate monomer is stearyl or lauryl (meth)acrylate, preferably stearyl methacrylate. Polyfunctional (meth)acrylate monomers include difunctional and trifunctional (meth)acrylates. Suitable, illustrative difunctional (meth)acrylates include 1,12 dodecane diol diacrylate, 1,3-butylene glycol diacrylate, 1,4-butanediol diacrylate, 1,6-hexanediol diacrylate (e.g., SR238B from Sartomer Chemical Co.), alkoxylated hexanediol diacrylate, alkoxylated neopentyl glycol diacrylate, cyclohexane dimethanol diacrylate, diethylene glycol diacrylate (e.g., SR230 from Sartomer Chemical Co.), ethoxylated (4) bisphenol A diacrylate (e.g., SR601 from Sartomer Chemical Co.), neopentyl glycol diacrylate, polyethylene glycol (400) diacrylate (e.g., SR344 from Sartomer Chemical Co.), propoxylated (2) neopentyl glycol diacrylate (e.g., SR9003B from Sartomer Chemical Co.), tetraethylene glycol diacrylate (e.g., SR268 from Sartomer Chemical Co.), tricyclodecane dimethanol diacrylate (e.g., SR833S from Sartomer Chemical Co.), triethylene glycol diacrylate (e.g., SR272 from Sartomer Chemical Co.), and tripropylene glycol diacrylate.

Suitable, illustrative trifunctional (meth)acrylates include ethoxylated (9) trimethylol propane triacrylate, pentaerythritol triacrylate, propoxylated (3) glyceryl triacrylate (e.g., SR9020 from Sartomer Chemical Co.), propoxylated (3) trimethylol propane triacrylate (e.g., SR492 from Sartomer Chemical Co.).

Preferred examples of suitable polyfunctional (meth)acrylate monomers include SR 834 (tricyclodecanedimethanol dimethacrylate), SR 348 (ethoxylated (n) bisphenol A dimethacrylate), SR 238 (1,6-hexanediol diacrylate), SR 262 (1,12-dodecanediol dimethacrylate), CD 595 (acrylate ester), SR 239 (1,6-hexanediol dimethacrylate), SR 214 (1,4-butanediol dimethacrylate), and SARBIO 5201 (acrylate ester), all available commercially from Sartomer Chemical Co., Exton, Pa.

The at least one unsaturated compound selected from the group consisting of an alkyl (meth)acrylate monomer and a polyfunctional (meth)acrylate monomer may be included in the present curable compositions in various suitable amounts. In embodiments, the at least one unsaturated compound selected from the group consisting of an alkyl (meth)acrylate monomer and a polyfunctional (meth)acrylate monomer is present in the curable composition in an amount ranging from about 1 weight % to about 40 weight %, based on the total weight of the curable composition. This includes embodiments in which the at least one unsaturated compound selected from the group consisting of an alkyl (meth)acrylate monomer and a polyfunctional (meth)acrylate monomer is present in an amount ranging from about 1 weight % to about 30 weight %, from about 5 weight % to about 20 weight %, from about 10 weight % to about 18 weight %, based on the total weight of the curable composition.

The at least one unsaturated compound selected from the group consisting of an alkyl (meth)acrylate monomer and a polyfunctional (meth)acrylate monomer disclosed above may be partially or fully hydrogenated.

In embodiments, the total amount of at least one unsaturated compound selected from the group consisting of an alkyl (meth)acrylate monomer and a polyfunctional (meth)acrylate monomer present in the curable composition is not more than 70 weight %, based on the total weight of the curable composition. This includes embodiments in which the total amount is not more than 65 weight %, not more than 60 weight %, not more than 55 weight %, not more than 50 weight %, not more than 45 weight %, or not more than 40 weight %, based on the total weight of the curable composition. This includes embodiments in which the total amount is in the range of from about 35 weight % to less than 60 weight %, from about 35 weight % to less than 55 weight %, from about 35 weight % to about 50 weight %, or from about 35 weight % to about 45 weight %, based on the total weight of the curable composition.

An Optional Photo-Blocker

Compositions disclosed herein may comprise a photo-blocker, which functions to block light from passing or absorb light, thereby serving to reduce the rate of curing of the composition upon exposure to actinic radiation such as, for example, UV or visible radiation. The specific photo-blocker may be selected on the basis of the specific wavelength of radiation to be blocked, the extinction coefficient of the light absorbing material at the prescribed wavelength, and the absence of adverse photoreactions or adverse involvement in the polymerization reaction. One example of a photoblocker for use with an ultraviolet radiation source having a peak emission wavelength of 350 nm is 2,2′-dihydroxy-4,4′-dimethoxybenzophenone. Another example is Reactint Yellow X36HS, a colorant-containing polyol commercially available from Milliken.

If used, the photo-blocker may be included in the composition in various suitable amounts. In embodiments, a composition includes from about 0.2 wt. % to about 15 wt. % of a photo-blocker, based on the total weight of the composition. This includes embodiments in which the composition includes from about 0.2 wt. % to about 10 wt. % or from about 1.0 wt. % to about 5 wt. % of the photo-blocker based on the total weight of the composition. In embodiments in which more than one species of photo-blocker is present in the composition, these amounts may refer to the total amount of photo-initiator in the composition.

Miscellaneous Optional Components

In addition to these compounds, the curable compositions disclosed herein can comprise conventional polymerization inhibitors, conventional fillers, further pigments and conventional additives, as employed in the 2D RF industry, coatings industry or the printing inks industry. Also suitable as pigments are phyllosilicates, titanium dioxide, colored pigments, calcium carbonate and kaolin and suitable fillers are for example silicon dioxide or aluminum silicate. As additives, conventional additives from the coatings industry or printing inks industry can be employed, in particular dispersants, re-dispersing agents, polymerization inhibitors, antifoams, catalysts, adhesion promoters, flow agents, thickeners or matting agents.

In some embodiments, the filler is added to increase thermal conductivity and mechanical strength, and/or reduce thermal expansion. The suitable fillers may be fused silica, quartz, talc aluminum silicate and soft silica. Suitable fillers may have a particle size in a range of 0.5 μm-15 μm.

If employed, fillers may be present in the compositions disclosed herein in an amount of from about 1 to about 60 wt. %, preferably from about 5 to about 45 wt. %, most preferably from about 20 to about 35 wt. %.

In other embodiments, at least one polymerization inhibitor is added in an amount to prevent gelation of the photo-curable composition.

The compositions disclosed herein optionally comprise a flame retarder in order to decrease flammability of the low dielectric material. Halogen-containing flame retardants and flame retardants without halogen may be used. The halogen-containing flame retardants may comprise decabromodiphenyl ethane. The flame retardants without halogen may comprise phosphorus-containing flame retardants and phosphates. The phosphor-containing flame retardants and phosphates are produced by ALBEMARLE CO., LTD.

If employed, flame retardants may be present in the compositions disclosed herein in an amount of from about 1 to about 35 wt. %, preferably from about 5 to about 28 wt. %.

The components of the composition disclosed herein may be mixed together by any means known to those skilled in the art. The process for preparing the resin composition of the present invention comprises, by common methods, matching, stirring, and mixing the methacrylate-modified polyphenylether resin, MQ organosilicon resin containing unsaturated double bonds and having a three-dimensional network structure and hydrolytically condensed from monofunctional siloxane unit (M unit) and tetrafunctional silica unit (Q unit), radical initiator, flame retardant and powder filler, and various thermosetting resins and additives.

The photo-curable compositions disclosed herein may have a viscosity over a wide range. Preferably, the compositions have a viscosity within a range suitable to be processed by a 3D printer at the printing temperature. In most cases, the printing temperature is room temperature (e.g., about 25° C.), but some 3D printers are configured to print products at higher temperatures. Preferably, the compositions of the present invention exhibit a viscosity of from about 200 cPs to about 100 kcPs, preferably 500 cPs to about 20 kcPs, and most preferably 1000 cPs to about 10 kcPs at the printing temperature, as measured by a Brookfield viscometer at 25° C. using spindle 31 sp at 50-100 rpm.

In an embodiment of the invention, the following constituents are used: (1) from about 12 wt. % to about 18 wt. % of a (meth)acrylated polydiene derivative which is a hydrophobic aliphatic urethane diacrylate; (2) about 35 wt. % to about 50 wt. % of triallyl isocyanurate; (3) about 10 wt. % to about 20 wt. % of SA9000; (4) about 10 wt. % to about 15 wt. % of a first diluent which is tricyclodecanedimethanol dimethacrylate; (5) about 10 wt. % to about 18 wt. % of a second diluent which is stearyl methacrylate; and (6) about 2 wt. % to about 5 wt. % of a photo-initiator, which is BPO Speedcure.

Process

Disclosed are photo-curable compositions and processes to produce a 3D high-frequency dielectric material for use as an insulator in a circuit such as, for example, a high-performance RF component such as, for example, an antenna for electromagnetic transmission, a filter, a transmission line, or an interconnect. The high frequency circuit structures have a very low dielectric loss at operating frequencies (1-60 GHz).

Disclosed herein is a process of forming a three-dimensional (3D) high-frequency circuit structure, said process comprising the steps of: I) irradiating a region of a photo-curable composition at a site of irradiation to form a cured region; and; and II) causing relative movement between the site of irradiation and the cured region to grow the cured region in the direction of the movement, wherein the photo-curable ink composition comprises: a. at least one (meth)acrylated polydiene derivative; b. at least one ethylenically unsaturated isocyanurate or cyanurate; c. optionally, at least one aromatic vinyl monomer; d. optionally, at least one functionalized poly(phenylene ether) having the following structure:

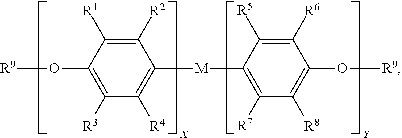

wherein ≤1x≤100; 1≤y≤100; 2≤x+y≤100; the examples are 15<x+y<30; 25 <x+y<40; 30<x+y<55; 60<x+y<85; 80<x+y<98;

M is selected from the group consisting of:

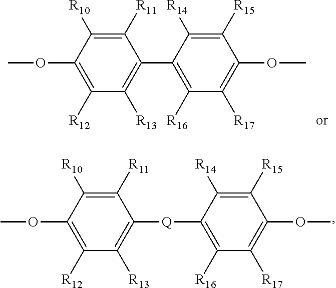

wherein Q is any one selected from the group consisting of —O—, —CO—, SO, —SO₂—, and —CH₂—, —C(CH₃)₂—;

R₂, R₄, R₆, R₈, R₁₁, R₁₃, R₁₅ and R₁₇ are all any one independently selected from the group consisting of a hydrogen atom, substituted or unsubstituted Cᵢ-Cₛ linear chain alkyl group, substituted or unsubstituted 0₁-Cₛ branched chain alkyl group and substituted or unsubstituted phenyl;

R₁, R₃, R₅, R₇, R₁₀, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

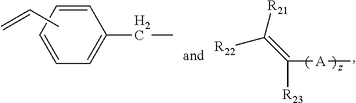

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms; at least one photo-initiator; at least one first diluent comprising an unsaturated alkyl difunctional (meth)acrylate monomer; and optionally at least one photoblocker.

The process can be a continuous process or a non-continuous process (i.e., step-wise or layer-wise). Suitable methods of the continuous type are sometimes referred to in the art as “continuous liquid interface (or interphase) product (or printing)” (“CLIP”) methods. Such methods are described, for example, in WO 2014/126830; WO 2014/126834; WO 2014/126837; and Tumbleston et al., “Continuous Liquid Interface Production of 3D Objects,” Science Vol. 347, Issue 6228, pp. 1349-1352 (Mar. 20, 2015), the entire disclosures of which is incorporated herein by reference in its entirety for all purposes.

When stereolithography is conducted above an oxygen-permeable build window, the production of an article using a curable composition in accordance with the present invention may be enabled in a CLIP procedure by creating an oxygen-containing “dead zone” which is a thin uncured layer of the curable composition between the window and the surface of the cured article as it is being produced. In such a process, a curable composition is used in which curing (polymerization) is inhibited by the presence of molecular oxygen; such inhibition is typically observed, for example, in curable compositions which are capable of being cured by free radical mechanisms. The dead zone thickness which is desired may be maintained by selecting various control parameters such as photon flux and the optical and curing properties of the curable composition. The CLIP process proceeds by projecting a continuous sequence of actinic radiation (e.g., UV) images (which may be generated by a digital light-processing imaging unit, for example) through an oxygen-permeable, actinic radiation- (e.g., UV-) transparent window below a bath of the curable composition maintained in liquid form. A liquid interface below the advancing (growing) article (i.e., the cured region) is maintained by the dead zone created above the window. The curing article is continuously drawn out of the curable composition bath above the dead zone, which may be replenished by feeding into the bath additional quantities of the curable composition to compensate for the amounts of curable composition being cured and incorporated into the growing article. In another example, continuous processes typically involve conveying a target substrate on which the printing is to occur by means of, for example, a conveyor belt.

In a non-continuous or layer-wise process, the cured region is a first cured layer and the process further comprises the steps of III) irradiating the photo-curable composition adjacent the cured first layer to form a subsequent cured layer; and IV) optionally, repeating steps II) and III) to form any additional layer(s) to form the 3D high-frequency circuit structure.

The layer (or first, prior, or previous layer), subsequent layer (or second or latter layer), and any additional layer(s), optionally present as described below, are collectively referred to herein as “the layers.” “The layers,” as used herein in plural form, may relate to the layers at any stage of the process, e.g., in an uncured state, in a partially cured state, in a final cure state, etc.

As with the layer, the subsequent layer (or any subsequent layer) formed by printing the photo-curable composition may have any shape and dimension. For example, the subsequent layer need not be continuous or have a consistent thickness. Further, the subsequent layer may differ from the layer in terms of shape, dimension, size, etc.

In certain embodiments, printing of the subsequent layer occurs before the at least partially cured layer has reached a final cure state, i.e., while the at least partially cured layer is still “green.” As used herein, “green” encompasses a partial cure but not a final cure state. The distinction between partial cure and a final cure state is whether the partially cured layer can undergo further curing or cross-linking. Functional groups may be present even in the final cure state but may remain unreacted due to steric hindrance or other factors. In these embodiments, printing of the layers may be considered “wet-on-wet” such that the adjacent layers at least physically bond, and may also chemically bond, to one another.

The layers can each be of various dimension including thickness and width. Thickness and/or width tolerances of the layers may depend on the 3D printing process used, with certain printing processes having high resolutions and others having low resolutions. Thicknesses of the layers can be uniform or may vary, and average thicknesses of the layers can be the same or different. Average thickness is generally associated with thickness of the layer immediately after printing. In various embodiments, the layers independently have an average thickness of from about 1 to 10,000, about 2 to about 1,000, about 5 to about 750, about 10 to about 500, about 25 to about 250, or about 50 to about 100, μm. Thinner and thicker thicknesses are also contemplated. This disclosure is not limited to any particular dimension of any of the layers.

In an embodiment of the invention, the step of III) irradiating the photo-curable composition adjacent the cured first layer to form a subsequent cured layer comprises irradiating the subsequent layer with the energy source to form an at least partially cured subsequent layer. This step may be the same as or different from the step of I) irradiating a region of a photo-curable composition at a site of irradiation to form a cured region in terms of the curing condition and associated parameters applied.

The photo-curable composition disclosed herein may also be printed on a substrate such as, for example an electronic substrate, such that a layer of the intended component is formed on the substrate. The substrate may be rigid or flexible and may be discontinuous or continuous in at least one of thickness and composition.

As understood in the art, the rate and mechanism with which the photo-curable ink composition cures is contingent on various factors, including the components thereof, functional groups of the components, parameters of the curing condition, etc. Once irradiated, the layer generally begins to cure. Exothermic and/or applied heat may accelerate cure of the layer.

In certain embodiments, the cured layer substantially retains its shape upon exposure to ambient conditions. Ambient conditions refer to at least temperature, pressure, relative humidity, and any other condition that may impact a shape or dimension of the at least partially cured layer. For example, ambient temperature is room temperature.

More specifically, prior to irradiation, the photo-curable ink composition is generally viscous but flowable and may be in the form of a liquid, slurry, or gel, alternatively a liquid or slurry, alternatively a liquid. Viscosity of the photo-curable ink composition can be adjusted depending on the type of 3D printer and its dispensing techniques and other considerations. Adjusting viscosity can be achieved, for example, by heating or cooling the photo-curable ink composition, or by adding or removing a solvent, carrier and/or diluent, or by adding a filler or thixotropic agent, etc.

The energy source independently utilized for the curing steps may emit various wavelengths across the electromagnetic spectrum. In various embodiments, the energy source emits at least one of ultraviolet (UV) radiation, infrared (IR) radiation, visible light, X-rays, gamma rays, or electron beams (e-beam). One or more energy sources may be utilized.

In certain embodiments, the energy source emits at least UV radiation. In physics, UV radiation is traditionally divided into four regions: near (400-300 nm), middle (300-200 nm), far (200-100 nm), and extreme (below 100 nm). Three conventional divisions have been observed for UV radiation: near (400-315 nm); actinic (315-200 nm); and vacuum (less than 200 nm). In specific embodiments, the energy source emits UV radiation, alternatively actinic radiation. The terms of UVA, UVB, and UVC are also common in industry to describe the different wavelength ranges of UV radiation.

In certain embodiments, the radiation utilized to cure the layer(s) may have wavelengths outside of the UV range. For example, visible light having a wavelength of from 400 nm to 800 nm can be used. As another example, IR radiation having a wavelength beyond 800 nm can be used.

In other embodiments, e-beam can be utilized to cure the layer(s). In these embodiments, the accelerating voltage can be from about 0.1 to about 100 keV, the vacuum can be from about 10 to about 10⁻³ Pa, the electron current can be from about 0.0001 to about 1 ampere, and the power can vary from about 0.1 watt to about 1 kilowatt. The dose is typically from about 100 micro-coulomb/cm² to about 100 coulomb/cm², alternatively from about 1 to about 10 coulombs/cm². Depending on the voltage, the time of exposure is typically from about 10 seconds to 1 hour; however, shorter or longer exposure times may also be utilized.

Optionally, steps II) and III) can be repeated for any additional layer(s) to form the 3D article. The total number of layers required will depend, for example, on the desired RF component or other article.

Further, if desired, a composite including all or some of the layers may be subjected to a final cure step. For example, to ensure that the 3D article is at a desired cure state, a composite formed by printing and at least partially curing the layers may be subjected to a further step of irradiating. The final cure step, if desired, may be the same as or different from the previous curing steps in terms of curing condition, associated parameters, and source of radiation utilized.

This disclosure generally incorporates ASTM Designation F2792-12a, “Standard Terminology for Additive Manufacturing Technologies,” by reference in its entirety. Under this ASTM standard, “3D printer” is defined as “a machine used for 3D printing” and “3D printing” is defined as “the fabrication of objects through the deposition of a material using a print head, nozzle, or another printer technology.” “Additive manufacturing (AM)” is defined as “a process of joining materials to make objects from 3D model data, usually layer upon layer, as opposed to subtractive manufacturing methodologies. Synonyms associated with and encompassed by 3D printing include additive fabrication, additive processes, additive techniques, additive layer manufacturing, layer manufacturing, and freeform fabrication.” AM may also be referred to as rapid prototyping (RP). As used herein, “3D printing” is generally interchangeable with “additive manufacturing” and vice versa.

The process disclosed is able to produce a the insulating element of a 3D high-frequency circuit structure such as, for example, a high-performance RF component such as, for example, an antenna for electromagnetic transmission, a filter, a transmission line, or an interconnect. The high frequency circuit structures have a very low dielectric loss at operating frequencies (1 GHz -60 GHz).

The photo-curable compositions disclosed herein, when printed and photo-cured, exhibit a dielectric loss (D_{f}) of 0.007 or less, 0.006 or less, 0.005 or less, 0.004 or less, 0.003 or less from 10 MHz to 20 GHz with excellent breakdown strength. The photo-curable compositions disclosed herein, when printed and photo-cured, exhibit a dielectric constant (Dₖ) of 2.4 to 2.9 from 10 MHz to 20 GHz. The frequencies at which the cured compositions may be tested can vary over a wide range and might include values, such as 1, 5, 7, 8, 10, 12, 15, and 20 GHz.

In one embodiment, the printed and photo-cured 3D structure exhibits at least one of, and preferably both of, a dielectric loss (D_{f}) of less than 0.0035, preferably 0.0030, and most preferably 0.0028, measured using a Network Analyzer at 25° C. and a dielectric constant (Dk) of less than 2.75, preferably about 2.70, and most preferably about 2.68, at a frequency of 10.04 GHz.

In another embodiment of the invention, the article produced by the 3D printing process described herein is smooth, and preferably has an R_{z} surface roughness of preferably less than 10 microns, more preferably less than 5 microns, and most preferably less than 3 microns as measured by a profilometer.

### Aspects of the Invention

The invention relates to the following aspects:

[Aspect 1] A photo-curable composition suitable for 3D printing, the photo-curable composition comprising:

a. at least one (meth)acrylated polydiene derivative;

b. at least one ethylenically unsaturated isocyanurate or cyanurate;

c. optionally, at least one aromatic vinyl monomer;

d. optionally, at least one functionalized poly(phenylene ether) having the following structure:

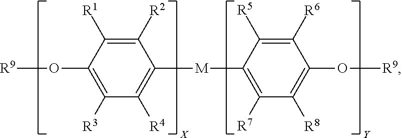

wherein 1≤x≤100; 1≤y≤100; 2≤x+y≤100; the examples are 15<x+y<30; 25<x+y<40; 30<x+y<55; 60<x+y<85; 80<x+y<98;

M is selected from the group consisting of:

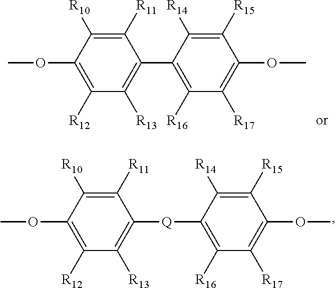

wherein Q is any one selected from the group consisting of —O—, —CO—, SO, —SO₂—, and —CH2—, —C(CH₃)₂—;

R₂, R₄, R₈, R₈, R₁₁, R₁₃, R₁₅ and R₁₇ are all any one independently selected from the group consisting of a hydrogen atom, substituted or unsubstituted C₁-C₈ linear chain alkyl group, substituted or unsubstituted C₁-C₈ branched chain alkyl group and substituted or unsubstituted phenyl;

R₁, R₃, R₅, R₇, R₁₀, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

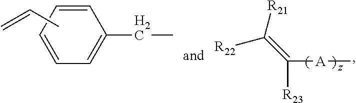

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms;

e. at least one photo-initiator;

f. at least one diluent selected from the group consisting of an aryl difunctional

(meth)acrylate monomer, an alkyl (meth)acrylate monomer; and a polyfunctional

(meth)acrylate monomer; and

g. optionally, at least one photoblocker.

[Aspect 2] The composition of aspect 1 wherein the at least one diluent comprises an unsaturated alkyl difunctional (meth)acrylate monomer and the composition further comprises at least one second diluent selected from the group consisting of an alkyl (meth)acrylate monomer and a polyfunctional (meth)acrylate monomer.

[Aspect 3] The composition of aspect 1 or 2 wherein the at least one (meth)acrylated polydiene derivative is selected from at least one of a (meth)acrylated hydroxy-polydiene, a polydiene-based epoxy (meth)acrylate, a polydiene-based polyester (meth)acrylate, a polydiene-based urethane (meth)acrylate and combinations thereof; in particular selected from the group consisting of a hydrophobic aliphatic urethane acrylate, a hydrophobic acrylate ester, and a polybutadiene diacrylate.

[Aspect 4] The composition of any of aspects 1-3 wherein the at least one ethylenically unsaturated isocyanurate or cyanurate is selected from the group consisting of triallyl cyanurate, triallyl isocyanurate, and tris(2-hydroxy ethyl) isocyanurate tri(meth)acrylate.

[Aspect 5] The composition of any of aspects 1-4 wherein the at least one aromatic vinyl monomer is present and is at least one selected from the group consisting of p-methylstyrene, divinyl benzene, dibromostyrene, and p-tert-butylstyrene.

[Aspect 6] The composition of any of aspects 1-5 wherein the at least one methacrylate-functionalized poly(phenylene ether) is present; preferably the methacrylate-functionalized poly(phenylene ether) is bifunctional and has the following structure:

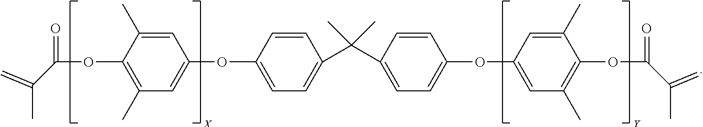

[Aspect 7] The composition of any of aspects 1-6 wherein the photo-initiator is selected from the group consisting of benzophenone and derivatives thereof, benzoin and derivatives thereof, acetophenone and derivatives thereof, anthraquinone, thioxanthone and derivatives thereof, and organophosphorus compounds.

[Aspect 8] The composition of any of aspects 1-7 wherein the composition is free of bismaleimide resins.

[Aspect 9] The composition of any of aspects 1 or 3-8 wherein the diluent is a cycloalkyl difunctional methacrylate.

[Aspect 10] The composition of any of aspects 2-9 wherein the second diluent is selected from the group consisting of stearyl methacrylate, lauryl methacrylate, stearyl acrylate, lauryl acrylate, behenyl acrylate, 3,3,5-trimethylcyclohexyl methacrylate, octyl decyl acrylate, tridecyl acrylate, and isodecyl methacrylate.

[Aspect 11] The composition of any of aspects 2-9 wherein the second diluent is stearyl or lauryl (meth)acrylate, preferably stearyl methacrylate.

[Aspect 12] The composition of any of aspects 2-9 wherein the second diluent is a polyfunctional (meth)acrylate monomer.

[Aspect 13] The composition of aspect 12 wherein the polyfunctional (meth)acrylate monomer is selected from the group consisting of ethoxylated (n) bisphenol A dimethacrylate, tricyclodecanedimethanol dimethacrylate, 1,6-hexanediol diacrylate, 1,12-dodecanediol dimethacrylate, 1,10-decanediol diacrylate, 1,6-hexanediol dimethacrylate, and1,4-butanediol dimethacrylate.

[Aspect 14] The composition of any of aspects 1-13 wherein the composition is free of thermal initiators.

[Aspect 15] The composition of any of aspects 1-14 further comprising a fire-retardant compound.

[Aspect 16] The composition of any of aspects 1-15 further comprising an inorganic filler.

[Aspect 17] The composition of aspect 16 wherein the inorganic filler is selected from the group consisting of high purity quartz, alumina, beryllia, aluminum nitride, and glass.

[Aspect 18] The composition of any of aspects 1-17 wherein the photoblocker is present.

[Aspect 19] A process of forming a three-dimensional (3D) high-frequency circuit structure, said process comprising the steps of:

I) irradiating a region of a photo-curable composition at a site of irradiation to form a cured region; and

II) causing relative movement between the site of irradiation and the cured region to grow the cured region in the direction of the movement,

wherein the photo-curable composition comprises:

a. at least one (meth)acrylated polydiene derivative;

b. at least one ethylenically unsaturated isocyanurate or cyanurate;

c. optionally, at least one aromatic vinyl monomer;

d. optionally, at least one functionalized poly(phenylene ether) having the following structure:

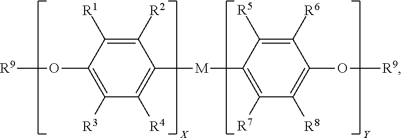

wherein 1≤x≤100; 1≤y≤100; 2≤x+y≤100; the examples are 15<x+y<30; 25<x+y<40; 30<x+y<55; 60<x+y<85; 80<x+y<98;

M is selected from the group consisting of:

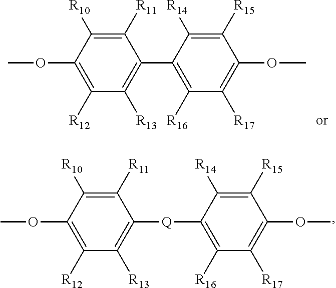

wherein Q is any one selected from the group consisting of —O—, —CO—, SO, —SO₂—, and —CH₂—, —C(CH₃)₂—;

R₂, R₄, R₈, R₈, R₁₁, R₁₃, R₁₅ and R₁₇ are all any one independently selected from the group consisting of a hydrogen atom, substituted or unsubstituted C₁-C₈ linear chain alkyl group, substituted or unsubstituted Cᵢ-Cₐ branched chain alkyl group and substituted or unsubstituted phenyl;

R₁, R₃, R₅, R₇, R₁₉, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and

R₉ is selected from the group consisting of:

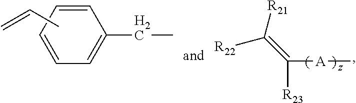

wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms;

e. at least one photo-initiator;

f. at least one diluent selected from the group consisting of an aryl difunctional (meth)acrylate monomer; an alkyl (meth)acrylate monomer; and a polyfunctional (meth)acrylate monomer; and

g. optionally at least one photoblocker.

[Aspect 20] The process of aspect 19 wherein the 3D structure is a cured resin for housing an antenna for electromagnetic transmission.

[Aspect 21] The process of either aspect 19 or 20 wherein the process is a continuous process performed at least in part on a conveyor device.

[Aspect 22] The process of any of aspects 19-21 wherein the cured region is a first cured layer and the process further comprises the steps of:

III) irradiating the photo-curable composition adjacent the cured first layer to form a subsequent cured layer; and

IV) optionally, repeating steps II) and III) to form any additional layer(s) to form the 3D high-frequency circuit structure.

[Aspect 23] The process of any of aspects 19-22 wherein the 3D structure exhibits a dielectric loss (D_{f}) of less than about 0.0028 measured using a Network Analyzer at 25° C.

[Aspect 24] The process of any of aspects 19-23 wherein the at least one diluent comprises an unsaturated alkyl difunctional (meth)acrylate monomer and the photo-curable composition further comprises at least one second diluent selected from the group consisting of an alkyl (meth)acrylate monomer and a polyfunctional (meth)acrylate monomer.

[Aspect 25] The process of any of aspects 19-24 wherein the at least one (meth)acrylated polydiene derivative is selected from the group consisting of a hydrophobic aliphatic urethane acrylate, a hydrophobic acrylate ester, and a polybutadiene diacrylate.

[Aspect 26] The process of any of aspects 19-25 wherein the at least one ethylenically unsaturated isocyanurate or cyanurate is selected from the group consisting of triallyl cyanurate, triallyl isocyanurate, and tris(2-hydroxy ethyl) isocyanurate tri(meth)acrylate.

[Aspect 27] The process of any of aspects 19-26 wherein the at least one aromatic vinyl monomer is present and is at least one selected from the group consisting of p-methylstyrene, divinyl benzene, dibromostyrene, and p-tert-butylstyrene.

[Aspect 28] The process of any of aspects 19-27 wherein the at least one methacrylate-functionalized poly(phenylene ether) is present; preferably the methacrylate-functionalized poly(phenylene ether) is difunctional and has the following structure:

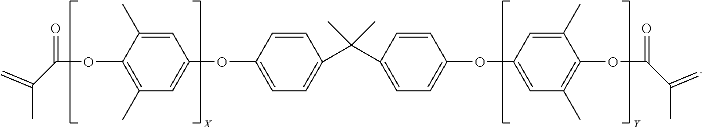

[Aspect 29] The process of any of aspects 19-28 wherein the photo-initiator is selected from the group consisting of benzophenone and derivatives thereof, benzoin and derivatives thereof, acetophenone and derivatives thereof, anthraquinone, thioxanthone and derivatives thereof, and organophosphorus compounds.

[Aspect 30] The process of any of aspects 19-29 wherein the composition is free of bismaleimide resins.

[Aspect 31] The process of any of aspects 19-23 or 25-30 wherein the first diluent is a cycloalkyl difunctional methacrylate.

[Aspect 32] The process of any of aspects 24-30 wherein the second diluent is selected from the group consisting of stearyl methacrylate, lauryl methacrylate, stearyl acrylate, lauryl acrylate, behenyl acrylate, 3,3,5-trimethylcyclohexyl methacrylate, octyl decyl acrylate, tridecyl acrylate, and isodecyl methacrylate.

[Aspect 33] The process of any of aspects 24-30 wherein the second diluent is stearyl or lauryl (meth)acrylate, preferably stearyl methacrylate.

[Aspect 34] The process of any of aspects 24-30 wherein the second diluent is a polyfunctional (meth)acrylate monomer.

[Aspect 35] The process of aspect 34 wherein the polyfunctional (meth)acrylate monomer is selected from the group consisting of ethoxylated (n) bisphenol A dimethacrylate, tricyclodecanedimethanol dimethacrylate, 1,6-hexanediol diacrylate, 1,12-dodecanediol dimethacrylate, 1,10-decanediol diacrylate, 1,6-hexanediol dimethacrylate, and1,4-butanediol dimethacrylate.

[Aspect 36] The process of any of aspects 19-35 wherein the composition is free of thermal initiators.

[Aspect 37] The process of any of aspects 19-36 wherein the composition further comprises a fire-retardant compound.

[Aspect 38] The process of any of aspects 19-37 wherein the composition further comprises an inorganic filler.

[Aspect 39] The process of aspect 38 wherein the inorganic filler is selected from the group consisting of high purity quartz, alumina, beryllia, aluminum nitride, and glass.

[Aspect 40] The process of any of aspects 19-39 wherein the photoblocker is present in the composition.

[Aspect 41] The composition of any of aspects 1, 3-9, or 14-18, wherein the at least one diluent comprises stearyl methacrylate.

[Aspect 42] The process of any of aspects 19-23, 24-30, or 36-40, wherein the at least one diluent comprises stearyl methacrylate.

The compositions and processes disclosed herein will be illustrated in more detail with reference to the following Examples, but it should be understood that the it is not deemed to be limited thereto.

### EXAMPLES

Materials

The following materials were used in the examples:

| | | |
|---|---|---|
| SA9000 | methacrylate-functionalized polyphenylether | SABIC |
| | resin (PPO) | |
| CN310 | polydiene-based aliphatic urethane diacrylate | Arkema |
| CN310MA | polydiene-based aliphatic urethane | Arkema |
| | dimethacrylate | |
| CN307 | polydiene-based polyester acrylate | Arkema |
| SR533 | triallyl isocyanurate | Arkema |
| SR834 | tricyclodecanedimethanol dimethacrylate | Arkema |
| SR324 | C16-C18 alkyl methacrylate | Arkema |
| SR257 | stearyl acrylate | Arkema |
| SR262 | 1,12-dodecanediol dimethacrylate | Arkema |
| SR335 | lauryl acrylate | Arkema |
| SR523 | allyl functional methacrylate monomer | Arkema |
| SR351H | trimethylolpropane triacrylate | Arkema |
| TPO-L | ethyl (2,4,6-trimethylbenzoyl) phenyl | Arkema |
| | phosphinate (photoinitiator) | |
| Ir 819 | 1-hydroxycyclohexyl phenyl ketone | BASF |
| | (photoinitiator) | |
| SpeedCure | phenyl bis(2,4,6-trimethylbenzoyl)-phosphine | Arkema |
| BPO | oxide (photoinitiator) | |
| Yellow dye | Reactint Yellow X36HS (photoblocker) | Milliken |
| Uvitex | 2,5-bis(5-tert-butyl-2-benzoxazol-2-yl) | BASF |
| OB+ | thiophene | |

Methods

The following methods were used herein:

Curing

The liquid curable composition was UV cured between glass sheets to 500 μm target thickness in a Dymax flood lamp for 15 s per side to ensure complete cure and featured a thickness uniformity of less than ±4%. The cured product was then dried in a thermal chamber at 60° C. for 1 hour prior to testing to ensure elimination of moisture.

Thickness

Thickness was measured using a Heidenhain Metro gauge accurate to ±0.2 μm. Five thicknesses over the area to be tested and their average was used for calculations.

Dielectric constant and Dielectric loss

The dielectric constant (Dk) and dielectric loss (D_{f}) were measured at 25° C. using a Keysight N5222A PNA with a 85072A 10 GHz split cylinder test fixture.

Breakdown Strength and Shape Factor

Breakdown strength (BDS) was measured following the ASTM D-149 standard (ramping at 500 V/s) at 25° C. This test utilizes a ¼ stainless steel ball on a brass plate immersed in silicone oil to minimize the electric field non-uniformity and the chances of a film defect being present at the test location. ASTM D-149 returns a value that approaches the entitlement BDS of the sample. The breakdown strength thickness was measured in a 2mm diameter circle drawn on each 20-30 μm thick film using permanent marker and the respective thickness was recorded prior to breakdown. This was done so the ball in plane measurement could be placed on the exact spot that the thickness measurement was taken. 20 measurements were made on each test film and the data set was fit using a 2-parameter Weibull distribution.

### Example 1

Curable compositions were obtained by mixing the following ingredients at 60° C. until completely mixed and homogenous (the amounts are in % by weight based on the weight of the composition)

| | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|
| SA9000 | 25 | 25 | 25 | 25 | 25 | 25 | 20 | 20 | 25 | 20 | 20 | 20 | 20 | | | 6 | 6 | 6 |
| CN310 | 25 | 25 | 25 | 25 | 25 | | 12 | 12 | | 12 | 12 | 12 | 25 | 16 | 16 | | | |
| CN310MA | | | | | | | | | | | | | | | | 16 | 16 | 16 |
| CN307 | | | | | | 25 | | | 12 | | | | | | | | | |
| SR533 | 10 | 10 | 10 | 34 | 49 | 34 | 42 | 67 | 47 | 44 | 42 | 42 | 42 | 48 | 48 | 48 | 48 | 48 |
| SR834 | | | 14 | | | | | | | | | | | 35 | 35 | 18 | 18 | 18 |
| SR324 | | 10 | | 15 | | | 25 | | 15 | 23 | | | 12 | | | 11 | 11 | 11 |
| SR257 | | | | | | 15 | | | | | 25 | | | | | | | |
| SR262 | 29 | 29 | 15 | | | | | | | | | | | | | | | |
| SR335 | 10 | | 10 | | | | | | | | | 25 | | | | | | |
| TPO-L | | | | | | | | | | | | | | | 1 | | 1 | |
| Irg 189 | 1 | 1 | 1 | 1 | 1 | 1 | 1 | 1 | 1 | 1 | 1 | 1 | 1 | 1 | | 1 | | 1 |
| Yellow dye | | | | | | | | | | | | | | | | | | 0.08 |
| Uvitex OB+ | | | | | | | | | | | | | | | | | 0.08 | |

The compositions were cured according to the method described herein and the dielectric constant (Dk) and dielectric loss (D_{f}) were measured according to the method described herein. The table below shows the dielectric properties obtained with Samples 1-18. The effects of various monomers and oligomers can be seen on the resultant Dk and Df properties at 10 GHz.

| Sample | Dk (10 GHz average) | Df (10 GHz average) |
|---|---|---|
| 1 | 2.52 | 0.00459 |
| 2 | 2.50 | 0.00408 |
| 3 | 2.54 | 0.00435 |
| 4 | 2.61 | 0.00272 |
| 5 | 2.61 | 0.00275 |
| 6 | 2.67 | 0.00414 |
| 7 | 2.79 | 0.00345 |
| 8 | 2.74 | 0.00237 |
| 9 | 2.80 | 0.00343 |
| 10 | 2.94 | 0.00386 |
| 11 | 2.70 | 0.00397 |
| 12 | 2.71 | 0.00453 |
| 13 | 2.67 | 0.00280 |
| 14 | 2.62 | 0.00382 |
| 15 | 2.78 | 0.00410 |
| 16 | 2.60 | 0.00351 |
| 17 | 2.72 | 0.00360 |
| 18 | 2.60 | 0.00377 |

### Example 2

Curable compositions were obtained by mixing the following ingredients (the amounts are in % by weight based on the weight of the composition). The compositions were cured according to the method described herein and the dielectric constant (Dk) and dielectric loss (D_{f}) were measured at according to the method described herein.

| | | | Dk | Df |
|---|---|---|---|---|
| | | Photoinitiator | (10 GHz | (10 GHz |
| Monomer (%) | Oligomer (%) | (%) | average) | average) |
| SR533 (50%) | CN310 (49%) | BPO (1%) | 2.86343 | 0.00443 |
| SR533 (35%) | CN310 (64%) | BPO (1%) | 2.77166 | 0.00394 |
| SR533 (20%) | CN310 (79%) | BPO (1%) | 2.71555 | 0.00367 |
| SR523 (50%) | CN310 (49%) | BPO (1%) | 2.75076 | 0.01294 |
| SR523 (35%) | CN310 (64%) | BPO (1%) | 2.70044 | 0.00991 |
| SR523 (20%) | CN310 (79%) | BPO (1%) | 2.67819 | 0.00693 |
| SR351H (50%) | CN310 (49%) | BPO (1%) | 2.63790 | 0.00848 |
| SR351H (35%) | CN310 (64%) | BPO (1%) | 2.58899 | 0.00706 |
| SR351H (20%) | CN310 (79%) | BPO (1%) | 2.55008 | 0.00539 |
| | CN310 (99%) | BPO (1%) | 2.59324 | 0.00360 |

This example shows that a trifunctional acrylate monomer having an isocyanurate structure (such as SR533) has an advantageous effect for reducing Df and increasing Dk with respect to a conventional trifunctional acrylate monomer (such as SR351H or SR523) at 10 GHz.

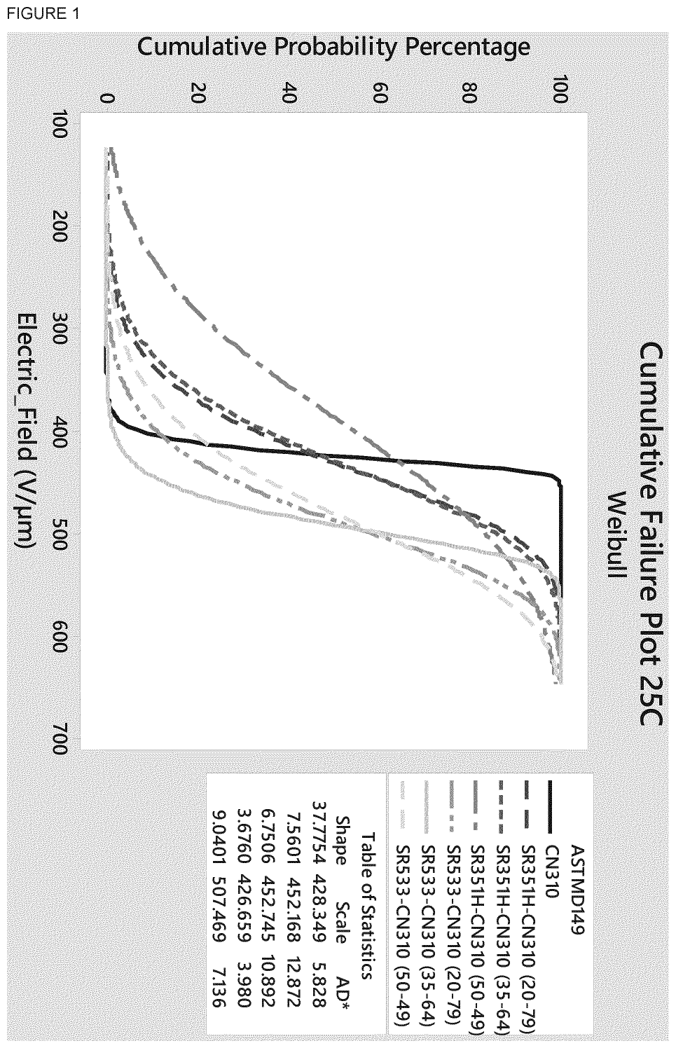

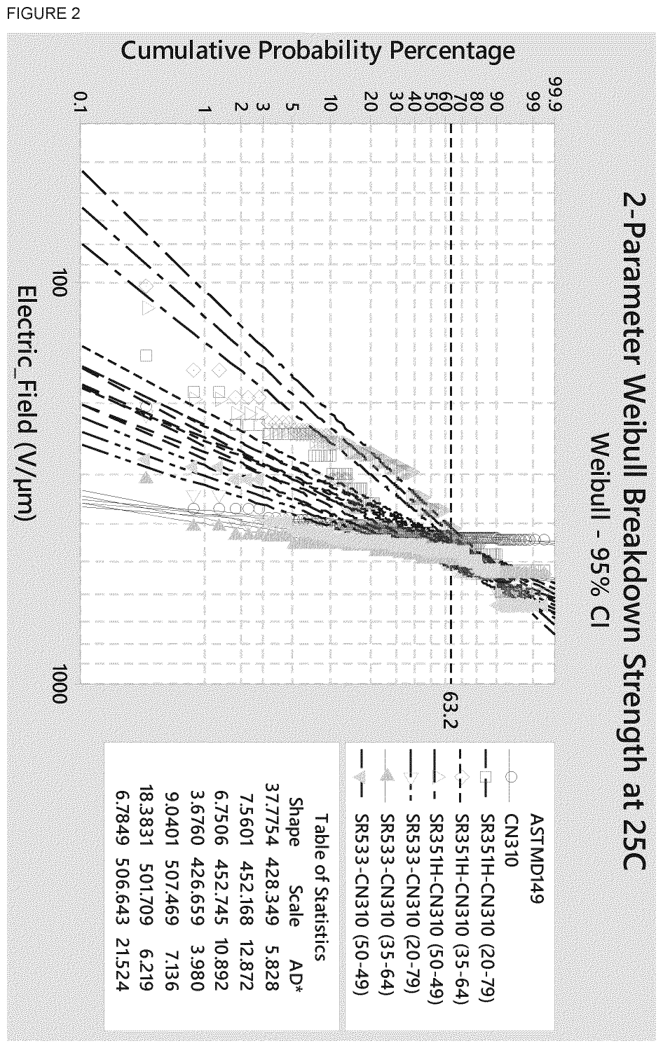

The breakdown strength and shape factor were measured according to the method described herein. FIGS. 1 and 2 clearly show a statistical difference between samples composed of SR351H which feature a lower breakdown strength and shape factor(426-452V/μm) vs. samples that are composed of SR533 which feature higher breakdown strength and shape factor (501-507 V/μm). Breakdown strength of this resin is a very important property of the end use application as these materials are passing very high currents and must maintain operating as an insulator throughout their application life.

### Prophetic Examples

Formulations according to the following embodiments of the invention could be made. The following constituents in the following amounts could be used: (1) from about 12 wt. % to about 18 wt. % of a (meth)acrylated polydiene derivative which is a hydrophobic aliphatic urethane diacrylate; (2) about 35 wt. % to about 50 wt. % of triallyl isocyanurate; (3) about 10 wt. % to about 20 wt. % of SA9000; (4) about 10 wt. % to about 15 wt. % of a first diluent which is tricyclodecanedimethanol dimethacrylate; (5) about 10 wt. % to about 18 wt. % of a second diluent which is stearyl methacrylate; and (6) about 3 wt. % to about 5 wt. % of a photo-initiator, which is Speedcure BPO. The viscosities of these formulations could range from 2,000 to 10,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of the invention would have a dielectric loss (D_{f}) of less than about 0.0035 measured using a Network Analyzer at 25° C. and a dielectric constant (Dk) of about 2.68.

The following constituents in the following amounts could be used: (1) from about 15 wt. % to about 22 wt. % of a (meth)acrylated polydiene derivative which is a hydrophobic aliphatic urethane diacrylate; (2) about 35 wt. % to about 50 wt. % of triallyl isocyanurate; (3) about 4 wt. % to about 10 wt. % of SA9000; (4) about 10 wt. % to about 20 wt. % of a first diluent which is tricyclodecanedimethanol dimethacrylate; (5) about 10 wt. % to about 18 wt. % of a second diluent which is stearyl methacrylate; and (6) about 1 wt. % to about 5 wt. % of a photo-initiator, which is Speedcure BPO. The viscosities of these formulations could range from 2,000 to 20,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.004 measured using a Network Analyzer at 25° C. and a dielectric constant (Dk) of about 2.70.

The following constituents in the following amounts could be used: (1) from about 20 wt. % to about 27 wt. % of a (meth)acrylated polydiene derivative which is a hydrophobic aliphatic urethane diacrylate; (2) about 35 wt. % to about 50 wt. % of triallyl isocyanurate; (3) about 10 wt. % to about 20 wt. % of SA9000; (4) about 10 wt. % to about 18 wt. % of a second diluent which is stearyl methacrylate; and (5) about 1 wt. % to about 5 wt. % of a photo-initiator, which is Speedcure BPO. The viscosities of these formulations could range from 2,000 to 20,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.003 measured using a Network Analyzer at 25° C. and a dielectric constant (Dk) of about 2.67.

The following constituents in the following amounts could be used: (1) from about 10 wt. % to about 15 wt. % of a (meth)acrylated polydiene derivative which is a hydrophobic aliphatic urethane diacrylate; (2) about 35 wt. % to about 50 wt. % of triallyl isocyanurate; (3) about 15 wt. % to about 20 wt. % of SA9000; (4) about 18 wt. % to about 28 wt. % of a diluent which is lauryl methacrylate; and (5) about 1 wt. % to about 5 wt. % of a photo-initiator, which is Speedcure BPO. The viscosities of these formulations could range from 2,000 to 20,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.0044 measured using a Network Analyzer at 25° C. and a dielectric constant (Dk) of about 2.67.

The following constituents in the following amounts could be used: (1) from about 10 wt. % to about 15 wt. % of a (meth)acrylated polydiene derivative which is a hydrophobic aliphatic urethane diacrylate; (2) about 35 wt. % to about 50 wt. % of triallyl isocyanurate; (3) about 15 wt. % to about 20 wt. % of SA9000; (4) about 18 wt. % to about 28 wt. % of a diluent which is stearyl acrylate; and (5) about 1 wt. % to about 5 wt. % of a photo-initiator, which is Speedcure BPO. The viscosities of these formulations could range from 2,000 to 20,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.0040 measured using a Network Analyzer at 25° C. and a dielectric constant (Dk) of about 2.69.

The following constituents in the following amounts could be used: (1) from about 10 wt. % to about 15 wt. % of a (meth)acrylated polydiene derivative which is a hydrophobic aliphatic urethane diacrylate; (2) about 35 wt. % to about 50 wt. % of triallyl isocyanurate; (3) about 15 wt. % to about 20 wt. % of SA9000; (4) about 18 wt. % to about 28 wt. % of a diluent which is stearyl methacrylate; and (5) about 1 wt. % to about 5 wt. % of a photo-initiator, which is Speedcure BPO. The viscosities of these formulations could range from 2,000 to 15,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.0035 measured using a Network Analyzer at 25° C. and a dielectric constant (Dk) of about 2.74.

The following constituents in the following amounts could be used: (1) from about 10 wt. % to about 15 wt. % of a (meth)acrylated polydiene derivative which is a hydrophobic aliphatic urethane diacrylate; (2) about 35 wt. % to about 50 wt. % of triallyl isocyanurate; (3) about 15 wt. % to about 20 wt. % of SA9000; (4) about 18 wt. % to about 28 wt. % of a diluent which is stearyl methacrylate; and (5) about 1 wt. % to about 5 wt. % of a photo-initiator, which is Speedcure TPOL. The viscosities of these formulations could range from 2,000 to 15,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.0036 measured using a Network Analyzer at 25° C. and a dielectric constant (Dk) of about 2.75.

The following constituents in the following amounts could be used: (1) from about 10 wt. % to about 15 wt. % of a (meth)acrylated polydiene derivative which is a hydrophobic acrylate ester; (2) about 35 wt. % to about 50 wt. % of triallyl isocyanurate; (3) about 15 wt. % to about 25 wt. % of SA9000; (4) about 10 wt. % to about 23 wt. % of a diluent which is stearyl methacrylate; and (5) about 1 wt. % to about 5 wt. % of a photo-initiator, which is Speedcure BPO. The viscosities of these formulations could range from 2,000 to 15,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.0035 measured using a Network Analyzer at 25° C. and a dielectric constant (Dk) of about 2.77.

The following constituents in the following amounts could be used: (1) from about 20 wt. % to about 28 wt. % of a (meth)acrylated polydiene derivative which is a hydrophobic aliphatic urethane diacrylate; (2) about 10 wt. % to about 20 wt. % of triallyl isocyanurate; (3) about 17 wt. % to about 25 wt. % of SA9000; (4) about 10 wt. % to about 20 wt. % of a first diluent which is tricyclodecanedimethanol dimethacrylate; (5) about 10 wt. % to about 18 wt. % of a second diluent which is stearyl methacrylate; and (6) about 10 wt. % to about 18 wt. % of a third diluent which is 1,12 dodecanediol dimethacrylate; and (7) about 1 wt. % to about 5 wt. % of a photo-initiator, which is Speedcure BPO. The viscosities of these formulations could range from 2,000 to 20,000 cPs. Such compositions could be cured using any known 3D printer. The cured product could then be tested for dielectric loss and dielectric constant at 10.04 GHz according to IPC test method TM-650 2.5.5.13. It is submitted that certain optimized formulations of this embodiment of the invention would have a dielectric loss (D_{f}) of less than about 0.0037 measured using a Network Analyzer at 25° C. and a dielectric constant (Dk) of about 2.45.

Although illustrated and described above with reference to certain specific embodiments and prophetic examples, embodiments disclosed herein are nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

1. A photo-curable composition suitable for 3D printing, the photo-curable composition comprising:
a. at least one (meth)acrylated polydiene derivative;
b. at least one ethylenically unsaturated isocyanurate or cyanurate;
c. optionally, at least one aromatic vinyl monomer;
d. optionally, at least one functionalized poly(phenylene ether) having the following structure: 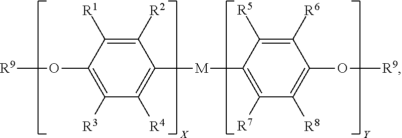
wherein 1≤x≤100; 1≤y≤100; 2≤x+y≤100;
M is selected from the group consisting of: 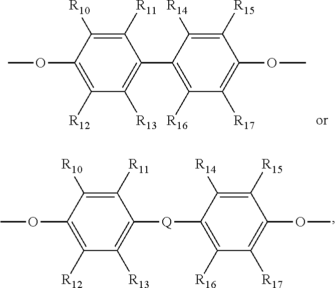
wherein Q is any one selected from the group consisting of —O—, —CO—, SO, —SO₂—, and —CH₂—, —C(CH₃)₂—;
R₂, R₄, R₆, R₈, R₁₁, R₁₃, R₁₅ and R₁₇ are all any one independently selected from the group consisting of a hydrogen atom, substituted or unsubstituted C₁-C₈ linear chain alkyl group, substituted or unsubstituted C₁-C₈ branched chain alkyl group and substituted or unsubstituted phenyl;
R₁, R₃, R₅, R₇, R₁₀, R₁₂, R₁₄ and R₁₆ are all independently selected from the group consisting of: a hydrogen atom, substituted or unsubstituted C₁-C₈ linear chain alkyl group, substituted or unsubstituted C₁-C₈ branched chain alkyl groups and substituted or unsubstituted phenyl; and
R₉ is selected from the group consisting of: 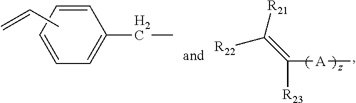
wherein A is selected from the group consisting of: arylene, carbonyl, or alkylene having 1-10 carbon atoms; Z is an integer from 0-10; and R₂₁, R₂₂ and R₂₃ are all independently selected from: a hydrogen atom or an alkyl having 1-10 carbon atoms;
e. at least one photo-initiator;
f. at least one diluent selected from the group consisting of an aryl difunctional (meth)acrylate monomer, an alkyl (meth)acrylate monomer; and a polyfunctional (meth)acrylate monomer; and optionally, at least one photoblocker.

2. The composition of claim 1, wherein the at least one diluent comprises an unsaturated alkyl difunctional (meth)acrylate monomer and the composition further comprises at least one second diluent selected from the group consisting of an alkyl (meth)acrylate monomer and a polyfunctional (meth)acrylate monomer.

3. The composition of claim 1, wherein the at least one (meth)acrylated polydiene derivative is selected from at least one of a (meth)acrylated hydroxy-polydiene, a polydiene-based epoxy (meth)acrylate, a polydiene-based polyester (meth)acrylate, a polydiene-based urethane (meth)acrylate and combinations thereof;

4. The composition of claim 1, wherein the at least one ethylenically unsaturated isocyanurate or cyanurate is selected from the group consisting of triallyl cyanurate, triallyl isocyanurate, and tris(2-hydroxy ethyl) isocyanurate tri(meth)acrylate.

5. The composition of claim 1, wherein the at least one aromatic vinyl monomer is present and is at least one selected from the group consisting of p-methylstyrene, divinyl benzene, dibromostyrene, and p-tert-butylstyrene.

6. The composition of claim 1, wherein the at least one methacrylate-functionalized poly(phenylene ether) is present; and has the following structure:

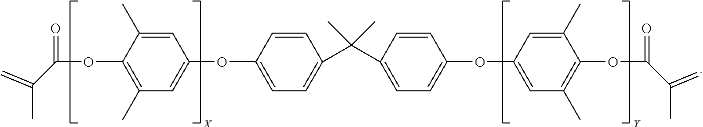

7. The composition of claims 1, wherein the photo-initiator is selected from the group consisting of benzophenone and derivatives thereof, benzoin and derivatives thereof, acetophenone and derivatives thereof, anthraquinone, thioxanthone and derivatives thereof, and organophosphorus compounds.

8. The composition of claim 1, wherein the composition is free of bismaleimide resins.

9. The composition of claim 1, wherein the at least one diluent is a cycloalkyl difunctional methacrylate.

10. The composition of claim 2, wherein the second diluent is selected from the group consisting of stearyl methacrylate, lauryl methacrylate, stearyl acrylate, lauryl acrylate, behenyl acrylate, 3,3,5-trimethylcyclohexyl methacrylate, octyl decyl acrylate, tridecyl acrylate, and isodecyl methacrylate.

11. The composition of claim 2, wherein the second diluent is a polyfunctional (meth)acrylate monomer selected from the group consisting of ethoxylated (n) bisphenol A dimethacrylate, tricyclodecanedimethanol dimethacrylate, 1,6-hexanediol diacrylate, 1,12-dodecanediol dimethacrylate, 1,10-decanediol diacrylate, 1,6-hexanediol dimethacrylate, and 1,4-butanediol dimethacrylate.

12. The composition of claim 1, wherein the composition is free of thermal initiators.

13. The composition of claim 1, further comprising a fire-retardant compound.

14. The composition of claim 1, further comprising an inorganic filler selected from the group consisting of high purity quartz, alumina, beryllia, aluminum nitride, and glass.

15. The composition of claim 1, wherein the photoblocker is present.

16. The composition of claim 1, wherein the at least one diluent comprises stearyl methacrylate.

17. A process of forming a three-dimensional (3D) high-frequency circuit structure, said process comprising the steps of:
I) irradiating a region of a photo-curable composition as defined in claim 1 at a site of irradiation to form a cured region; and
II) causing relative movement between the site of irradiation and the cured region to grow the cured region in the direction of the movement.

18. The process of claim 17, wherein the 3D structure is a cured resin for housing an antenna for electromagnetic transmission.

19. (canceled)

20. The process of claim 17, wherein the cured region is a first cured layer and the process further comprises the steps of:
III) irradiating the photo-curable composition adjacent the cured first layer to form a subsequent cured layer; and
IV) optionally, repeating steps II) and III) to form any additional layer(s) to form the 3D high-frequency circuit structure.

21. The process of claim 17, wherein the 3D structure exhibits a dielectric loss (D_{f}) of less than about 0.0028 measured using a Network Analyzer at 25° C.
